(19) United States
(12) Patent Application Publication
(10) Pub. No.: US 2011/0302408 A1
(43) Pub. Date: Dec. 8, 2011

(54) Secure Communication Systems, Methods, and Devices

(75) Inventors: Trevor McDermott, Dublin (IE); Robert Bruton, Dublin (IE)

(73) Assignee: MORRIGAN PARTNERS LIMITED, Dublin (IE)

(21) Appl. No.: 13/152,960

(22) Filed: Jun. 3, 2011

Related U.S. Application Data
(60) Provisional application No. 61/351,100, filed on Jun. 3, 2010.

(51) Int. Cl. H04L 9/32

(52) U.S. Cl. 713/153; 713/168

(57) ABSTRACT

In par, the invention relates to a secure communication system. The system includes a voice call processing server; a user database in communication with the server; and a security gateway in communication with the server and the database, wherein the gateway transmits an encrypted signaling key and at least one encrypted media key in response to validating a mobile device using configuration data stored in the database, wherein the server tracks call traffic encrypted using the at least one media key, the call traffic routed using the Internet.

### CROSS-REFERENCE TO RELATED APPLICATIONS

This application claims the benefit of U.S. Provisional Patent Application No. 61/351,100 filed Jun. 3, 2010, the entire disclosure of which is incorporated herein by reference.

### BACKGROUND

The ability to achieve secure communications faces many challenges. For example, standard mobile telecommunication network security upgrades are over a decade overdue and present significant technological and financial challenges to the major global mobile operators. Further, increased technological ability within the criminal and terrorist community, as well as corporate hacking, continually threatens the integrity of standard mobile security. These inherent structural weaknesses leave government security forces and law enforcement agencies at extreme risk when utilizing standard mobile networks for operational communication and for the transmission of critical data. Attempts to mitigate these risks to date have focused on expensive hardware devices or software with limited ability to operate across all networks, particularly 2G. These substandard applications severely impact the user experience, call quality and battery life of standard smart phones.

Accordingly, a need therefore exists for mobile device communication systems and software applications that address and improve upon these conditions.

### SUMMARY OF INVENTION

In one embodiment, the invention relates to systems, software, devices, and methods that facilitate secure communication between mobile devices using a low bandwidth codec such that communications are conducted over the internet or another network using a protocol such as a voice over internet protocol (VoIP) implementation.

In one further embodiment, the invention relates to a software application, such as a Secure Application (SA) sometimes also referred herein to as an MSA designed to provide secure communication for mobile devices. The application operates using a Voice over IP (VoIP) protocol. By using VoIP, mobile devices may make encrypted calls and also use an encrypted text messaging service.

In one embodiment, the encryption process is automatic and runs in the background of existing mobile operating systems. In addition, the process of configuring the mobile device is automatic in one embodiment. In one embodiment, configuration parameters are encrypted for transmission over the network and verified by the mobile device. In one embodiment, the amount of data transferred during this process is small (approximately 200 bytes or 0.2 kbytes) so that network speed is not important. The invention also relates to methods and systems that facilitate storing secure text, voice messages and data until the recipient is able to access it with their mobile device. In addition, secure voicemail services, secure conference calling and secure text messages are also different embodiments of the invention.

Because much of the world still uses 2G or lower bandwidth networks, one feature of the invention is to achieve secure communications over such low bandwidth networks. In part, this is achieved based on features of the SA and the use of codecs designed for such low bandwidth encrypted communications.

In one embodiment, the system, devices, and methods described herein use the identification number such as an IMEI or UDID, for example, for a given mobile device, such as a phone, as part of the authentication process to grant access to a private branch exchange or authentication server and/or commence encryption. In one embodiment, to provision a mobile device for use with an embodiment of a secure service described here two pieces of information are used. These two pieces of information include the phones standard number (or either its IMEI or UDID) and the configuration PIN that was supplied when a user subscribes to a secure service. In one embodiment, the configuration PIN is specific to only one mobile device.

In one embodiment, the invention relates to a secure communication system. The system includes a memory device; and a processor in communication with the memory device, wherein the memory device comprises instructions that when executed by the processor cause the processor to: validate a first mobile device; transmit a second key to the first mobile device; and initiate a secure internet-based voice call between the first mobile device and a second previously validated mobile device. The system can further include a conferencing module configured to cause the processor to execute instructions that cause the processor to initiate a secure connection between the first mobile device and two or more mobile devices for a secure conference call in response to selection of an icon on a user interface of the first mobile device. In one embodiment, the instructions that when executed by the processor further cause the processor to transmit a fourth key to the second mobile device in response to a third key sent from the mobile device. In one embodiment, the instructions that when executed by the processor further cause the processor to delete or cause the deletion of the second key and the fourth key after the secure internet-based voice call terminates.

In one further embodiment, the system can further include a private branch exchange server, wherein the processor and memory device is disposed therein. The system can further include a database executing in the memory device and in communication with the processor, the database comprising registered user information for a secure service and information relating to mobile devices of such users. The system can further include a secure VoIP gateway comprising an entropy module, a random number generator, and a network sampling module, wherein the entropy module receives signals obtained by the network sampling module and generates an entropy amount, the random number generator receiving and seeded by the entropy amount, wherein the random number generator generates at least one of a first key, the second key, a third key, or a fourth key. In one embodiment, the first mobile device comprises a memory, a mobile processor, an audio input, and an a secure application stored in memory, the secure application comprising a low bandwidth codec stored in memory that operates with the processor to encode voice signals received from the audio input and to encrypt such encoded voice signals using the second key.

In one further embodiment, the invention relates to the instructions that cause the processor to validate a first mobile device perform such validation in response to a first key sent from the first mobile device or a unique mobile device identifier such as the first mobile device's standard number, the first mobile device's International Mobile Equipment Identity (IMEI), or the first mobile device's Unique Device Identifier (UDID) and a configuration PIN registered to the user of the first mobile device. In one embodiment, the system can include a security module selected from the group consisting of a secure voicemail module configured to received encrypted voicemail messages on a mobile device; a secure text messages module configured to send and receive encrypted text messages on a mobile device; and a secure storage module configured to store secure text, voice, and other data on a mobile device.

In one further embodiment, the invention relates to secure communication system. The system includes a voice call processing server; a user database in communication with the server; and a security gateway in communication with the server and the database, wherein the gateway transmits an encrypted signaling key and at least one encrypted media key in response to validating a mobile device using configuration data stored in the database, wherein the server tracks call traffic encrypted using the at least one media key, the call traffic routed using the Internet. In one embodiment, the call traffic is encoded using a low bandwidth codec such that the encrypted call traffic can be transmitted over a 2G network. In one embodiment, the encrypted signally key is generated by a random number generator seeded with noise collected with respect to a communication channel of the Internet.

In one embodiment, the invention relates a method of conducting a secure communication between a first mobile device and a second mobile device. The method includes the steps of transmitting a first request for a first secure communication from a first mobile device to a secure VoIP gateway; transmitting a first key from the first mobile device to the secure VoIP gateway; receiving, by the first mobile device, a second key from the secure VoIP gateway; and encrypting a first communication using the second key to obtain a first encrypted communication. In one embodiment, the invention further includes the step of transmitting the first encrypted communication to a second mobile device. In one embodiment, the first communication is selected from the group consisting of a text message, an email message, a voice signal, and a voicemail message. In one embodiment, the first communication is an encoded voice signal. In one embodiment, the encoded voice signal was encoded using a low bandwidth codec. In one embodiment, the invention further includes the step of deleting the first key and the second key after the first secure communication terminates between the first and the second mobile devices. In one embodiment, the invention further includes steps of using a media stream to transmit one of the first or second keys and using a SIP signaling stream to transmit the other of the first or second keys.

In one embodiment, the invention relates to a computer system for supporting encrypted communications between a first mobile device and a second mobile device. The computer system includes a memory device; and a processor in communication with the memory device, wherein the memory device comprises instructions that when executed by the processor cause the processor to generate a first encryption key and process a received second encryption key for a phone call having a duration T, decrypt a first signal with one of the first or second encryption keys and erase the first encryption key and the second encryption key after the duration T expires when the phone call ends.

In one embodiment, the invention relates to a computer system for supporting encrypted communications between a first mobile device and a second mobile device. The system includes a mobile device user-interface responsive to a user action, the user-interface presenting the user with a plurality of encrypted call, encrypted conferencing, encrypted text messaging, or encrypted voicemail options; a codec configured to communicate encrypted voice signals over a 2G network; an event management module for monitoring network signals; an entropy collection module configured to collect an entropy measure based on the monitored network signals; and an encryption module configured to use random number generator outputs to encrypt an encoded signal from a user of the mobile device, the random number generator seeded with the entropy measure.

A tangible non-transitory computer-readable storage medium having computer-executable instructions stored thereon that, if executed by a computer based system for securing a communication channel between a first mobile device and a second mobile device, cause the computer based system to perform operations comprising: launching a graphical user interface to initiate a secure communication with a second mobile device; encoding an input voice signal with a low bandwidth codec to obtain a first encoded signal; encrypting the encoded signal with a first key to obtain a first encrypted encoded signal; and transmitting the first encrypted encoded signal to the second mobile device.

A computer program product for making secure communications between a first mobile device and a second mobile device, the computer program product includes a computer-readable tangible storage device and computer-readable program code stored thereon, the computer-readable program code includes: computer-readable program code to register a mobile device with a PBX; computer-readable program code to receive an encrypted call; computer-readable program code to generate a first key to encrypt outbound communications; computer-readable program code to process a received second key to decrypt inbound communications; and computer-readable program code to initiate a secure call in response to a user action using a graphic interface.

In one embodiment, the invention relates to a secure communication system that includes a network device to transmit a voice call made between at least two users using a target number; and a processor running a graphical user interface, wherein the processor includes instructions to: initiate a call when at least one user interacts with the processor; transmit the target number to a software module; use a transport level security connection to send a session initiation protocol invite to a secure server; digitize outbound media; and encrypt the outbound media to send said outbound media as a secure real-time transport protocol stream.

This Summary is provided merely to introduce certain concepts and not to identify any key or essential features of the claimed subject matter.

### BRIEF DESCRIPTION OF DRAWINGS

The figures are not necessarily to scale, emphasis instead generally being placed upon illustrative principles. The figures are to be considered illustrative in all aspects and are not intended to limit the invention, the scope of which is defined only by the claims.

FIG. 1 is a schematic diagram of an exemplary software-based system that provides secure and encrypted voice calls and other encrypted information in accordance with an illustrative embodiment of the invention.

FIG. 2 is a schematic diagram of subsystems of an exemplary software-based system that provides secure and encrypted voice calls and other encrypted information in accordance with an illustrative embodiment of the invention.

FIG. 3A is a schematic diagram of an exemplary software architecture components and data flows for a secure client application in accordance with an illustrative embodiment of the invention.

FIG. 3B is an exemplary graphic user interface home screen of a secure application on a mobile device in accordance with an illustrative embodiment of the invention.

FIG. 4 is a schematic diagram of an exemplary software-based system that provides secure and encrypted voice calls and various software components of a secure client application in accordance with an illustrative embodiment of the invention.

FIG. 5 is a schematic diagram of a mobile device receiving data and being configured for use with a software-based system that provides secure and encrypted voice calls and other encrypted information in accordance with an illustrative embodiment of the invention.

FIGS. 6A-6E are graphic user interfaces screens of a secure application on a mobile device in accordance with an illustrative embodiment of the invention.

FIGS. 7A-7E are graphic user interfaces screens of a secure application on a mobile device in accordance with an illustrative embodiment of the invention.

FIGS. 8A-8C are graphic user interfaces screens of a secure application on a mobile device in accordance with an illustrative embodiment of the invention.

### DETAILED DESCRIPTION

In one embodiment, the invention relates to systems, software, devices, and methods that facilitate secure communication between mobile devices such that communications are conducted over the internet or another network using a protocol such as a voice over internet protocol (VoIP) implementation. In one embodiment, the communications are conducted using a low bandwidth codec such that the communications can be conducted on a 2G or other type of network.

In one further embodiment, the invention relates to a software application, such as a Secure Application (SA or MSA) designed to provide secure communication for mobile devices. In one embodiment, the application operates using a Voice over IP (VoIP) protocol. By using VoIP, mobile devices may make encrypted calls and also use an encrypted text messaging service.

Because much of the world still uses 2G or lower bandwidth networks, one feature of the invention is to achieve secure communications over such low bandwidth networks. In part, this is achieved based on features of the SA and the use of codecs designed for such low bandwidth encrypted communications.

Prior to discussing embodiments of the invention in detail, an introduction to some of the characteristic terminology used herein may prove informative. However, the scope of the terms discussed herein is not intended to be limiting, but rather to clarify their usage and incorporate the broadest meaning of the terms as known to those of ordinary skill in the art.

In one embodiment, 2G refers to the 2^{nd} Generation cellular network which can include a cellular network offering lower data bandwidths. In one embodiment, 3G refers to the 3^{rd} Generation cellular network which can include a cellular network offering higher data bandwidths relative to 2G. In one embodiment, AES refers to Advanced Encryption Standard which can include a secure encryption algorithm used in government, military and commercial applications. In one embodiment, a codec refers to a software module that is used to convert voice or other data into a digital data stream suitable for transmission over a network. In one embodiment, a domain refers to part of an Internet web address or email address. Voice over Internet Protocol (“IP”) or VoIP services use domain names to locate the servers that are able to handle calls for a known user. VoIP can include a set of protocols for making voice or video calls over an IP network.

In one embodiment, GPRS refers to General Packet Radio Service which can include a data service running on GSM networks. GPRS provides the data service on 2G GSM networks, but the bandwidth is limited. The official GPRS data capacity on a 2G network is 56-114 Kbits/sec, in practice it is normally much lower. In one embodiment, Enhanced Data rates for GSM Evolution or EDGE (also known as Enhanced GPRS (EGPRS), or Enhanced Data rates for Global Evolution) refers to a digital mobile phone technology that allows improved data transmission rates as a backward-compatible extension of GSM. EDGE is standardized by 3GPP as part of the GSM family. In one embodiment, media refers to protocol that carries the audio (or video) streams that comprise a VoIP call.

In one embodiment, Media Stream refers to a related sequence of digital audio samples which form part of an audio phone call. In one embodiment, IP-PBX or PBX refers to a Private Branch Exchange or server suitable for processing a secure VoIP call. VoIP systems use the term PBX borrowed from traditional telephony systems to describe the server responsible for call processing. In one embodiment, provisioning refers to configuring a mobile device using configuration parameters. In one embodiment, such configuration parameters are transmitted and/or received over a network connection. In one embodiment, RNG refers to a random number generator which can be used to generate random numbers suitable for use as encryption keys or other purposes.

In one embodiment, RTP refers to a Real-time Transport Protocol. This protocol is used by some VoIP protocol suites for transporting media (audio or video). In one embodiment, signaling refers to a protocol that handles call setup, call termination and related functions in a VoIP system. In one embodiment, SIP refers to a Session Initiation Protocol. SIP is a standard based VoIP protocol suite. In one embodiment, SRTP refers to Secure RTP. Secure RTP is an encryption protocol used by some VoIP protocol suites for encrypting media. In one embodiment, TLS refers to transport level security. TLS is an encryption protocol used by some VoIP protocol suites for encrypting signaling traffic. TLS can also be used to encrypt website access.

In one embodiment, each user within a call group (two or more users) accesses suitable mobile device that includes an SA. Each such device links to a programmed central IP-PBX located in a secure hosting facility. Each user within the group is registered and authorized by adding their personal details (name, email address, etc.) and details of their phone (number and mobile device identifier) into a central database in one embodiment. Such a database or electronic datastore can also be located at a government or security agency hosting center.

Each mobile device authorized on the network runs a version of the secure or client application such as the SA. The application runs on a range of commercially available standard smart phones and connects to the best available communication network and establishes a secure encrypted and authenticated connection to the client controlled security gateway at the secure hosting center.

The SA utilizes this secure connection to register with the preconfigured PBX and security gateway. This registration or provisioning process signals to the PBX that the phone is active and provides it with the phone's current network address (network addresses will change as the phone moves between networks). Using the same secure connection, the system will establish calls via the PBX to other phones or to accept incoming calls routed via the PBX.

In one embodiment, the system will negotiate one-time encryption keys for all audio streams with the configured security gateway. These audio stream encryption keys are established using the existing secure connection between the phone and the security gateway. Two keys are use per phone/mobile device for each call, one for transmitted voice, and one for received voice. The keys are discarded at the end of the call. The system includes a unique bandwidth efficient codec so that a secure call VoIP call can be conducted on networks with limited bandwidth (for example GPRS).

The system software application installed on the smart phone is supported by a range of ancillary services to provide a complete security solution. These support systems include security gateway, an IP-PBX and an authorized user database, all of which are configured and managed by a secure application. The security gateway can be a government or security agency controlled gateway. Further, the system offers seamless operation over data-enabled networks including 2G, 3G and Wi-Fi.

In one embodiment, each encrypted call made through the system uses a minimum of two different encryption keys, so to intercept and decipher a single call would require that two such brute force attacks are completed.

Each phone registers with the configured PBX and establishes a secure connection (established automatically when the phone powers on). For example, if User A calls User B (via established secure connection) a request is relayed via encrypted channel to Gateway/PBX. PBX routes call to destination/User B via encrypted channel. Media encryption keys are agreed upon between the mobile devices via secure connections. Thus, secure bi-directional audio streams are established via encrypted channel, each with unique key (4 in total). In one embodiment, all calls are routed via secure hosting center to ensure call integrity. In turn, once the call terminates, audio stream keys discarded.

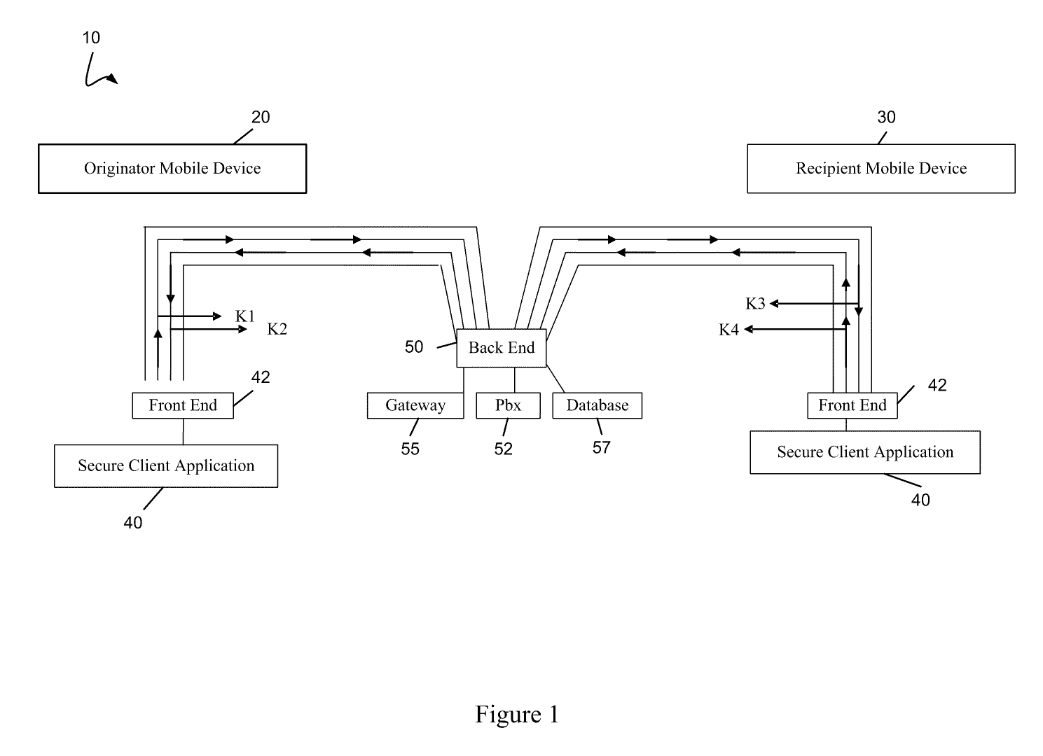

In part, one embodiment of the invention relates to a software-based system which provides secure and encrypted voice calls between mobile devices to prevent private conversations, text and data communication from being compromised. A high level schematic diagram of the system 10 is shown in FIG. 1.

As shown in FIG. 1 the left side of the figure shows a mobile device 20 such as a smart phone originating a call. Conversely, on the right side of the figure a mobile device 30 is shown as receiving call. However, since over the course of a given phone conversation the parties talk back and forth to each other, the reference frame for where a communication starts and ends changes depending on which side is talking and which side is listening. Each devices includes an exemplary SA 40.

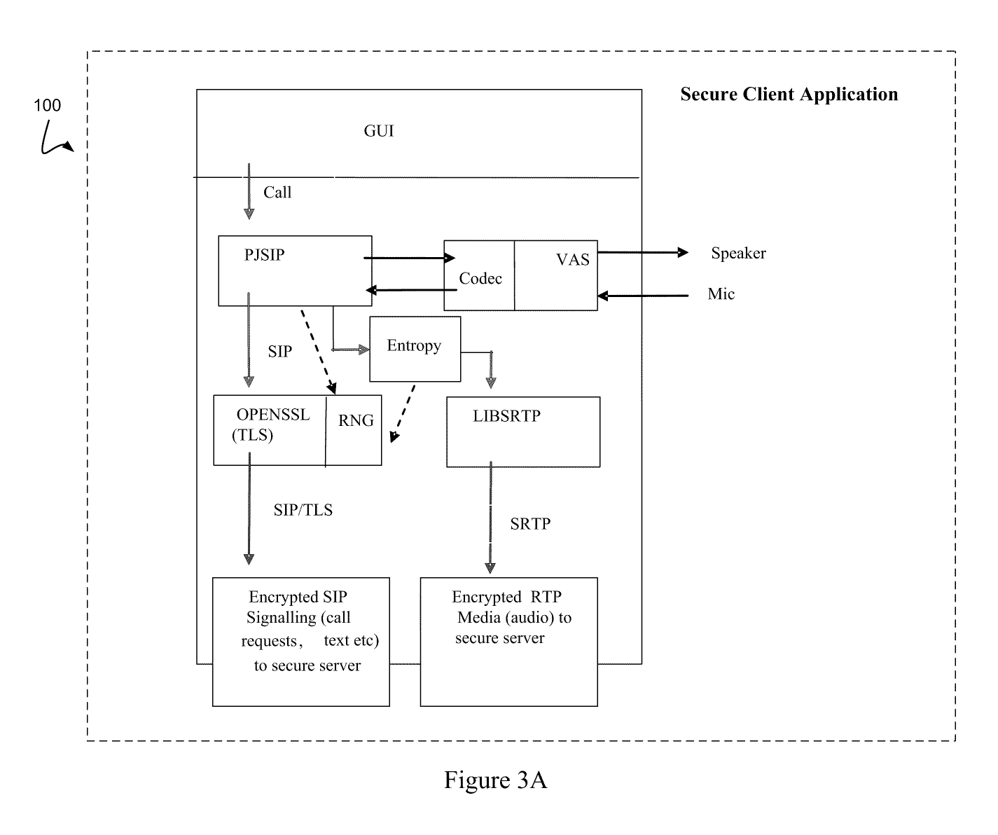

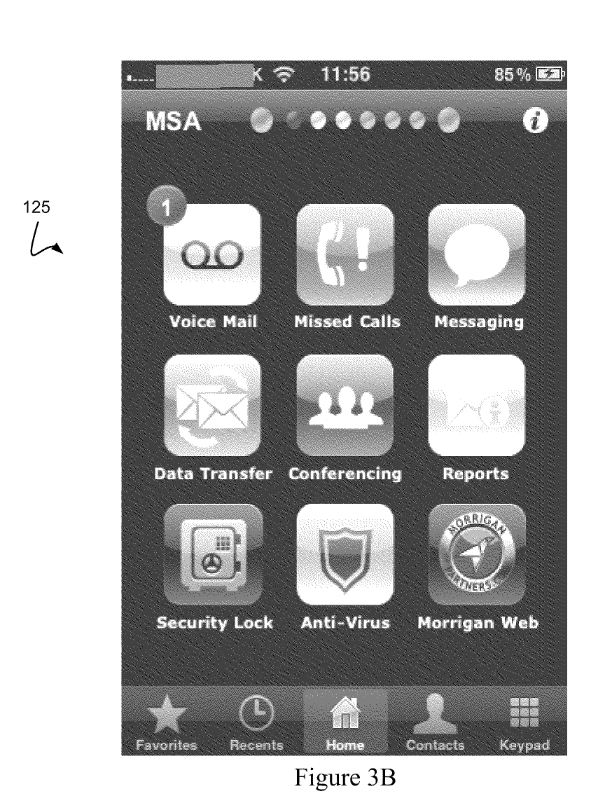

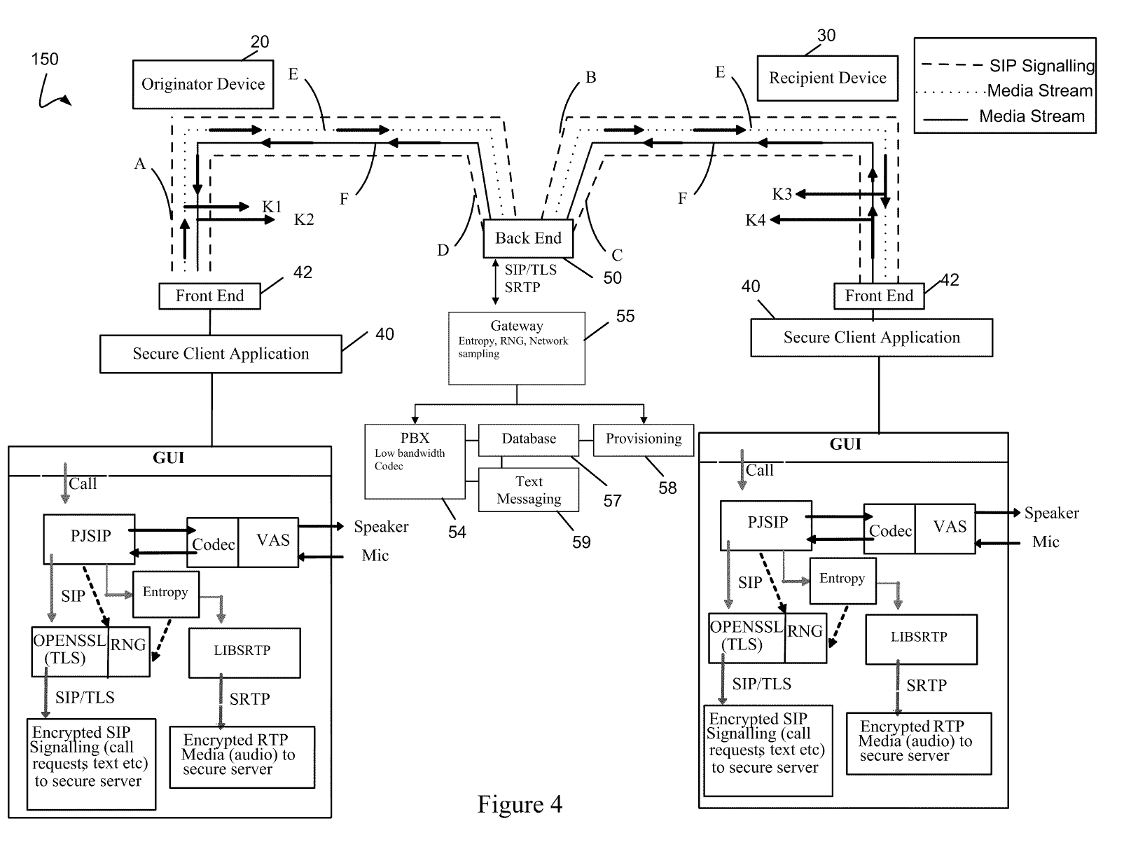

In general, one embodiment of the system 10, such as that shown in FIG. 1, has two main components; the mobile device client or secure application which are sometimes referred to as the front end 42 portions of the system and the back-end system 50. Mobile devices running the secure application or client 40 connect to the back-end system 50, register with that system and are then able to make encrypted calls with other registered devices and to exchange encrypted text messages with those devices. Additional details relating to subsystems or software modules within the client application are shown in FIGS. 3A and 4.

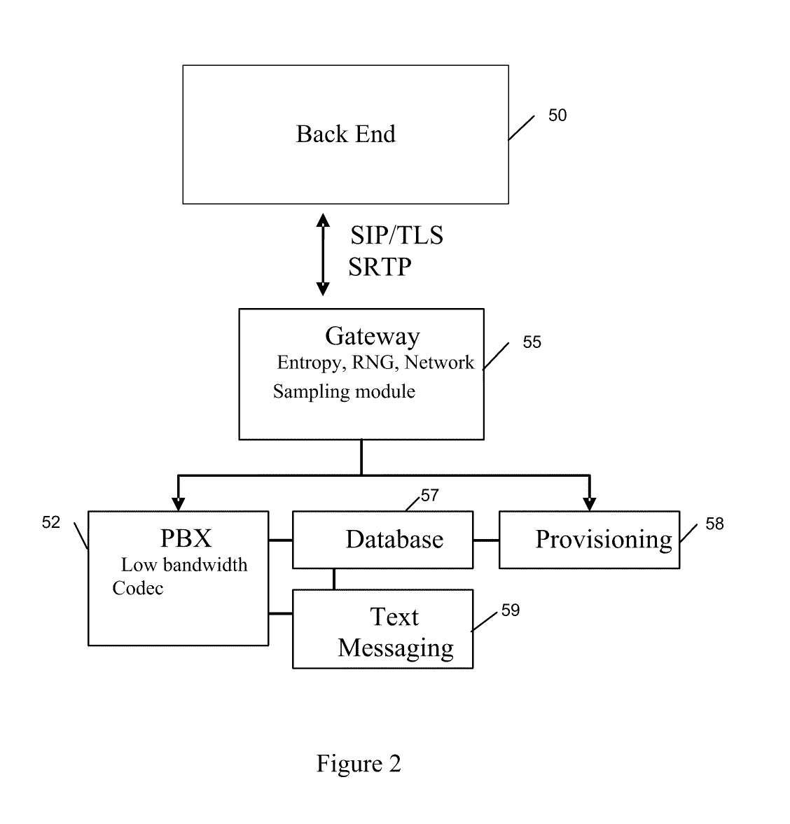

In FIG. 1 and in several of the other figures, each mobile device 20, 30 has the SA 40 resident in locale storage and/or executing on a processor within the mobile device. With the secure client application running on both phones, once the provision process to allow the phone to be recognized by the system is complete, the client applications interface with the back-end 50 as shown, specifically the PBX 52. In one embodiment, the back-end includes various pieces of hardware such as processor-based server that operates as a PBX 52 for VoIP call. The back-end can also include a secure gateway 55 as well as a database 57 populated with user information and other data. Additional details on the back-end 50 are shown in FIGS. 2 and 4.

In one embodiment, the back-end system is housed in a physically secure hosting center with high speed connections to the Internet. In addition to providing a secure VoIP and text messaging service, the back-end system also manages client provisioning. The components used to build the back-end system can include one or more of the following: a Secure VoIP Gateway 55, PBX 52, Database 57, Provisioning module 58 and Text Message Forwarding module 59. An exemplary flow of data between and among these components or subsystems is shown in FIG. 2. The Secure VoIP Gateway 55 can also include an entropy module, a RNG, and a network sampling module.

Using the system 10, an authorized user (originator phone or mobile device) can make a call over any mobile communications network to another authorized system user (recipient phone or mobile device) anywhere in the world, such that the content of the call is secure from interception, eavesdropping or misdirection. The advances made by in the delivery of the system 10 address these issues and provide a solution capable of mass deployment without compromising security or performance.

One system embodiment includes a secure VoIP service offering that incorporates various software and subsystems designed to enable secure VoIP calls and text messages within a group of users with supported mobile devices. The secure service is based on protocols including the Session Initiation Protocol (SIP) and runs on data networks linked to the Internet including 3G, GPRS and Wi-Fi.

The system embodiments operate seamlessly over all data-enabled networks including 2G, 3G and Wi-Fi. This allows mobile devices to move freely and uninterrupted between networks during a secure call connection. The ability for seamless network use including 2G is significant. With the system, methods, devices and software described herein and in the figures, secure and encrypted calling is as easy as making a standard network call, with a user interface eliminating complexity and latency on mobile devices.

### Security Gateway

Various components of an embodiment of the back-end portion of the system are shown in FIG. 2. The first component shown as the bridge between the front-end and the PBX is the security gateway or simply gateway 55. The gateway provides security and encryption functions for calls and messages to and from connected phones. Further, as shown, the flow of information between the gateway and the front can be handled using the SIP/TLS and SRTP features and protocols described herein.

The configured security gateway 55 is designed to provide security and encryption service for voice and related services such as instant messaging. In one embodiment, the gateway incorporates a number of security functions including:
Network security designed to protect the internal systems (PBX and database) from security threats. These controls are implemented in a firewall module.
Application security designed to protect the entire system from attacks such as call flooding and call disruption.
Content security designed to protect the entire system from threats such as unauthorized calls and eavesdropping on calls. The content security measures include encryption services. Various encryption features are described in more detail below.

With respect to FIG. 2, the gateway also includes subsystems relating to an entropy gathering module (entropy module), network sampling, and a random number generator. In this context, network sampling refers to an automated process that samples random network events (such as the time interval between the arrival of successive network packets). In addition, the RNG or pseudo random number generator (PRNG) is used to generate encryption keys for encrypting call set up and media traffic.

As shown later in FIG. 3A, an entropy module is again used. Two separate entropy modules are used in one embodiment because both the client and the security servers need to generate encryption keys and therefore each needs its own entropy source.

Additional details relating to the PBX's role as part of the back-end are shown in FIG. 2. In one embodiment, the IP-PBX (or simply PBX) is co-located with the configured Security Gateway that provides phone registration and call routing services. However, the PBX 52 and Security Gateway 55 can be in different locations in some embodiments. The IP-PBX is analogous to the exchange used to drive a standard corporate phone system. It is responsible for tracking the location of each phone registered and active phone and for routing secure and encrypted calls and text messages between phones. It also manages a voice mail service. In one embodiment, the PBX includes support and management of the low bandwidth codecs which cooperate with other system features to allow operation on 2G networks. The PBX is a server with one or more processors or processor cores. The PBX includes various software modules that execute on one or more of such processing elements.

Further, the PBX interfaces with the system software and security gateway management system, authorized users are also protected by the application of basic security features. For example, the PBX 52 can incorporate the following security features prior to the application of the security solution and encryption solution:
An IMEI number which is unique to each phone. The IMEI number is a unique 17 or 15 digit code used to identify an individual mobile device to a GSM or UMTS network.
The mobile device's existing SIM card serial number.
Existing phone number and username.
A randomly generated password from the application server.
The authorized user's personal password.

### Provisioning

In general, provisioning relates to the automated process of recognizing and authorizing a mobile device relative to the VoIP based system embodiments described (or other Internet based call embodiments). In one embodiment, the automated provisioning system includes two components; a back-end system that incorporates a database holding details of all users registered and authorized to use the system and a client-side component that installs the application and the configuration of the installed VoIP client. A provisioning module or system 58 is shown as part of the back-end of FIG. 2.

In one embodiment, the provisioning system enables the automated distribution, installation and configuration of the SA over an established network link. While software installation and configuration are closely related functions, they can be implemented with or without any in-built interdependencies. When no interdependencies are used, such an implementation enables alternative software distribution mechanisms which may offer a more efficient deployment mechanism. For example, if an organization wishes to deploy a large number of clients, a single copy of the application package can be supplied to the organization. The application may then be installed on a large number of phones before those phones are issued to users. The user's phone is then automatically provisioned on first use (subject to appropriate security controls).

In one embodiment, the provisioning process includes one or more steps. One such step can include registering a new user by entering user information (name, cell phone number, etc.) on a system operated by the provider of the secure application or another party. Another step can include loading software and configuration details on to the phone. Issuing the phone and/or installing a Secure Application/Secure Call Client can also be part of the provisioning process.

The client-side provisioning system provides automated application installation using a suitable network connection. Suitable network connections include 3G and WiFi. The application installation package can be provided on a web server as a single file including the signed core client application, any required additional components (such as the audio server) and the certificates that will be used to authenticate any TLS connections to the backend system. In one embodiment, the package will be provided in a form that will trigger an automatic installation.

The application package can include a certificate needed to validate TLS connections to the back-end system. TLS connections can be used to secure SIP transports. The certificates must be added to the phone's certificate store and marked as trusted for Internet connections and online certificate checks. The certificates are used as defined in the TLS standard (RFC 5246). When the client establishes a TLS connection to the server, the server presents a certificate. The client validates the chain of trust to validate the identity of the server.

In one embodiment, the provisioning system includes a user database 57 linked to the back-end PBX. The database and supporting tools register a new user by adding that user to the database and then automatically set up the PBX to process calls to and from that user and configure other services such as voice mail. Adding a user will also generate the configuration parameters needed for the user's phone. The configuration parameters govern the phone's behavior. They include the network location of the server and the client's identify and authentication parameters.

The provisioning system can also include a phone installation/configuration service. This provides an automated mechanism for downloading the secure client application package to the phone and applying the configuration parameters for that user. The configuration parameters are generated when the user is added to the database.

A system status console can also be incorporated as part of the provisioning system 58. This provides a user with an interface or viewer that displays an overview of the current system status and enables details and recent history for individual users to be displayed. In one embodiment, as part of the provisioning of a mobile device, the following steps are undertaking by the system software:

1. Mobile device makes a connection to the provisioning server sending its phone number to identify the mobile device.

2. Provisioning server looks up mobile device, if successful retrieves configuration info from database.

3. Configuration info is encrypted using a key derived from the mobile device's IMEI and a secret configuration PIN.

4. Phone downloads encrypted configuration info and prompts user to enter the PIN so that the configuration data can be decrypted.

5. If mobile device IMEI does not match the value stored in database for the supplied number, decryption will fail.

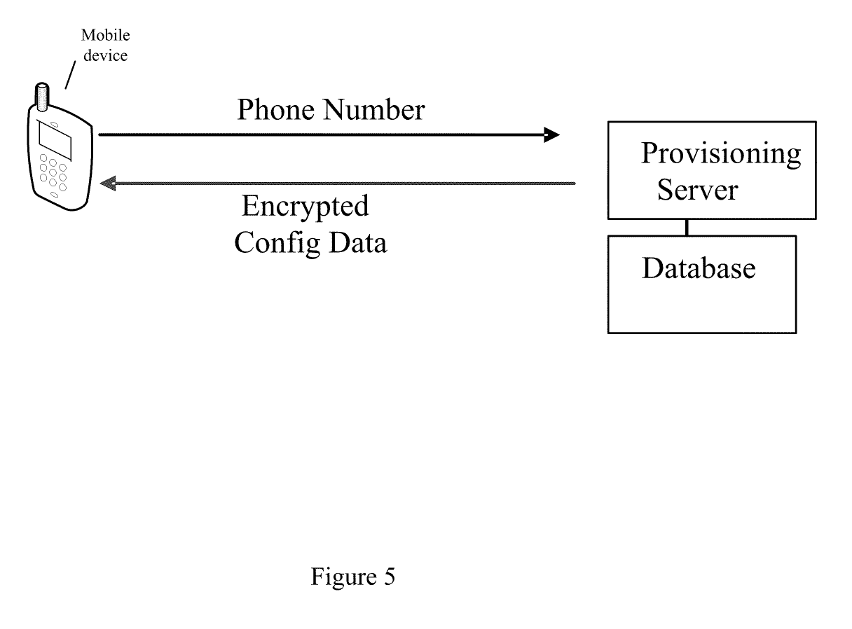

The flow of data in such an example is shown in FIG. 5. As show, some of the software features described in this section run a on a provisioning server which can be the same as or different from the PBX.

### Database

As discussed above, a user database is one part of the provisioning system or back-end 50. The database or datastore 57 can run or execute on one or more servers in one or more locations. One such location can include a secure hosting center. The database includes entries and fields with the details of all registered users. In one embodiment, access to the database is via a graphic user interface (GUI) such as a web-based or browser based GUI. The web GUI and associated software logic performs the following steps or operations: Registering a new user, Updating a user's registration details, Suspending or cancel a user's account, Generating a phone installation package for a new user, Generating an update package for all active phones or a defined sub-set of active phones (used when a new software update is available) and/or Display a recent activity history for the user (status monitoring function).

### Text Messaging

The text messaging forwarding module 59 of FIG. 2 provides messaging functionality to the back-end portion 50 of the overall system 10. The text messaging forwarding module 59 allows the PBX 52 to store received messages in a file along with sender and recipient addressing information, rather than to discard messages if the recipient is not in an active call. The nodule reads the stored messages and manages delivery and delivery notification. In one embodiment, the text forwarding module 59 uses a SIP MESSAGE method as defined in RFC 3261 to forward the message to the client over the secure TLS connection previously established from the SA to the PBX server.

### Secure Application Overview

In light of the discussion provided above with respect to several of the back-end features, it is informative to consider several of the front-end features such as those depicted in FIGS. 3 and 4. The Secure Client Application (SA) or Morrigan Partners Secure Client Application (MSA), which is also referred to herein in the alternative as a Secure Call Client (SCC), provides secure (encrypted) voice calls and secure text messaging between subscribers to the system. In one embodiment, there are two components to the secure service by which mobile device communicate. These include the Secure Application (SA) which runs on selected mobile devices as part of the front-end shown in FIGS. 1, 3A, and 4 and the secure communication servers running in a secure hosting facility as part of the back-end shown in FIGS. 1, 2, and 4.

Mobile devices running SA communicate with the secure communication servers using a suitable data network connection. The client is able to use GPRS, EDGE, 3G and Wi-Fi network connections. The mobile device user is able to specify a preferred set of networks which can include GPRS, EDGE, 3G and Wi-Fi. Specific details relating to the subsystems and flow data relative to the front-end client application are shown in FIGS. 3A and 4.

The secure communication servers include a VoIP PBX that routes calls between users and relays text messages and a provisioning server that handles mobile device configuration. These servers are protected by a SIP Security Controller. The SIP Security Controller is a commercial product that protects the PBX from all incoming traffic and any potential attacks. This controller includes both IP level and VoIP application level secure controls and also provides the encryption service that protects all calls and also text messages are encrypted.

In one embodiment, a SA running on a supported mobile device implements the same encryption services as the SIP Security Controller. Additional details relating to encryption features in the context of SRTP are provided below. In one embodiment, all calls between subscribed mobile devices are routed via the secure communication servers. This means that all calls between subscribers to the service are encrypted.

When the SA first starts, the application checks for a complete set of configuration parameters. If these parameters are not found, then the application will request a set of configuration parameters from a pre-defined web server. The phone's standard phone number will be used as a query parameter to identity a target phone.

Next, the SA will prompt the user to enter the phone number via the keypad. The entered value (with any spaces removed) will be added to a pre-defined URI and the resulting value used to retrieve the configuration parameters. The entered phone number should include the country code. The prompt displayed to the end-user should state: “please enter your mobile device phone number, including country code”. In one embodiment, the URI used to retrieve these parameters maybe of the form:

http://provisioning.morriganpartners.com/config/getconfig?id=phonenumber The domain morriganpartners.com can be replaced with any domain associated with the systems and services described herein. In one embodiment, this URI is hard-wired into the SA.

In one embodiment, the phone number parameter is the phone number of the mobile device. If the request specifies a phone number that is unknown to the back-end systems, the provisioning server will return a block of random data. The SA will recognize this block as invalid data and will not attempt to use these parameters. Returning this random block prevents a directory harvest attack whereby an attacker could attempt to retrieve the configuration parameters for a large range of numbers and thereby determine which of these numbers corresponded to active phones. A valid request will return a set of encrypted configuration parameters.

### Exemplary SA Mobile Device Functions

In addition to providing secure calls, voice mail and text messages to other users on the system, the Secure Application (SA) integrates with the standard mobile device phone book and maintains a log for calls and text messaging.

The secure conferencing service allows users to schedule conference calls and ensures that all participants' connections are encrypted. The secure data service will implement a, file sharing (pictures, videos, documents, notes, etc.) system that will enable subscribers that use SAs to exchange data securely.

### Exemplary Mobile Device Numbering Policy

Each mobile device registered with the service is identified within the service by a unique number. This number can be the same as the standard GSM number (including country code) that is assigned to the mobile device. For example a mobile device registered with a Provider with the number 087 123456 will be assigned the number 353 87 123456 within the system. This numbering policy means that users can import their existing phone book or selected entries from that phone book, into the client phonebook and make secure calls to those numbers (provided that the imported user has registered with the service).

### Subscribing to the Secure Service

Before using the secure service, a user must subscribe to the service so that their number is activated and the service enabled for their mobile device. Subscription is an administrative process and may require the following information:

1. The mobile device type make/model.

2. The phone number for the mobile device.

3. The mobile device's IMEI (dial *#06# to show the IMEI).

When the subscription process is complete, a user is provided with a configuration PIN which will be needed when the phone is first used. This PIN will enable the mobile device's configuration parameters to be automatically downloaded so that it may use the service. This PIN is valid only for the mobile device with the number and IMEI that matches the values provided.

### VoIP Protocols

The system described herein uses standards based VoIP protocols running over IP network connections to provide voice calls and text messages between mobile devices and the back-end systems. The standard implemented is the Session Initiation Protocol (SIP).

### Strength of Encryption

The system encrypts all communication between the mobile device and the back-end systems. This encryption protects both signaling (call setup) and media (audio streams). In one embodiment, the system uses TLS to encrypt the signaling streams. Other types and forms of encryption can be used. TLS uses two forms of encryption, asymmetric encryption to set up session encryption keys and a symmetric key algorithm (AES) for the connection between the mobile device and the backend systems.

In one embodiment, a new and unique encryption key is negotiated each time the mobile device connects to the back-end system. A new connection will be made each time the mobile device is powered on or each time the mobile device connects to a new network (for example switching from Wi-Fi to 3G). Each connection is secured by encryption keys of various sizes. In one embodiment, a 256 bit AES key is used. A key of this length provides strong encryption; studies show that a brute force attack on a 256 bit key would take 3×10⁵¹ years.

Various details of the processing of data of the SA and components of the SA are shown in FIG. 3B as an exemplary Secure Client Application or SA embodiment 100. Media streams are encrypted using SRTP. The SRTP standard specifies the use of a 128 bit AES key. Each media stream uses a unique key which is discarded at the end of the call. As each call has two media streams (one in each direction) two keys are used to secure each phone back to the server giving a total of four keys for every call to another user.

When a voice call is made between two users, both of whom are subscribed to the system or the secure service associated therewith, the caller's mobile device sends a call request to the secure communication servers. If those servers can locate the called user then a second call will be made from the secure communication servers to the called user. A call between two users therefore comprises two call portions, one from the call to the secure communication servers and a second to the called user.

The call set-up procedure that is followed by each call portion negotiates two encryption keys. One key is used to encrypt the audio stream between the mobile device and the secure communication servers, the other will be used for audio sent in the reverse direction. Each key is unique which means that a single call will use 4 different keys, two for each call leg. At the end of the call all four keys are discarded and no record of those keys is kept. In one embodiment, each of a 4 keys is a 128 bit AES key which takes 1,000 times the age of the Universe for a brute force crack. The encryption key used during call set up which protects the key exchange procedure is even stronger.

### Bandwidth Usage

The system is designed to provide an optimal or balanced tradeoff between call quality and network bandwidth usage. To achieve this, calls are transmitted using an efficient codec. This codec is adaptive reducing its bandwidth requirements in networks with limited capacity. The result is that calls on 3G and Wi-Fi networks provide good voice quality, while calls on 2G networks provide an acceptable level of call quality while using less than 14 Kbits/sec. The theoretical bandwidth available on 2G networks is 55 Kbits/sec. Call quality is dependent on network coverage and signal strength, if the phone is used in areas with low signal strength, call quality may suffer as with a normal GSM call.

Codec configuration involved making changes to the codec configuration parameters to obtain the optimum balance of bandwidth utilization and call quality. The codec is configured by changing a configuration file that is included in the PJSIP (an open source SIP stack) source code distribution. In one embodiment, the Speex codec is used as the low bandwidth codec.

### Mobile Device Security and SA Features

The system is designed to protect the confidentiality of communications over public networks. This protection is provided by encrypting calls and text message between the mobile device and the secure communication servers. This encryption system uses proven encryption algorithms with strong encryption keys. This combination provides effective protection against monitoring and eavesdropping at any point on the network between the mobile device and the secure communication servers. This protection is effective on both cellular networks and on Wi-Fi.

FIG. 3B shows an exemplary home user interface screen 125 for an exemplary SA. In one embodiment, the selectable components or regions of the home screen are: Voice Mail Icon; Missed Calls Icon; Text Messaging Icon; Data Transfer Icon; Conferencing Icon; Message Delivery Reports Icon; Security Lock Icon; Anti-Virus Icon; Short Cut to System Web Site; Favorites Menu; Recents (call log); Return to Home Screen; Contacts; and Keypad, for manually dialing calls. When one of these icons or features is selected a related software application is or process is launched to allow a user of the mobile device to perform the activity or function associated with the item on the home interface.

### Call Processing

Turning to FIG. 4, an overall system 150 showing various features from FIGS. 1, 2, and 3B are shown. As shown, when a mobile device 20 places a secure call to another mobile device 30, the calling mobile device 20 sends a SIP INVITE request over the secure TLS connection to the secure communication servers or back-end [see item A in FIG. 4]. This request includes a media stream encryption key or alternatively a first key (K₁) that will be used to encrypt the outbound audio stream when the call is established. K₁ is generated by the PRNG seeded with audio samples. The INVITE request is received by the secure communication servers. If the destination has completed a REGISTER request then the secure communication servers send an INVITE request to the destination mobile device [see item B in FIG. 4]. This request includes a media stream encryption key or alternatively a second key (K₂). This key will be used to encrypt audio streams sent to the destination mobile device. K₂ is generated by a PRNG on the secure communication servers or back-end. This PRNG is seeded using random data collected from network events.

When the destination phone answers the call, it sends a SIP OK message [see item C in FIG. 4] to the secure communication servers. This OK includes an encryption key or alternatively a third key (K₃) which will be used to encrypt the audio stream sent from the destination mobile device to the secure communication servers. Finally the secure communication servers send an OK to the originating mobile device [see item D in FIG. 4] and the call begins. This final OK includes an encryption key or alternatively a fourth key K₄ which encrypts the audio stream sent from the secure communication servers to the call originator.

The keys K₁ to K₄ are included in the SIP request using the format described in RFC 4568. The call audio streams are encrypted using SRTP. SRTP specifies the AES encryption protocol and is defined in RFC 3711 (The Secure Real-time Transport Protocol (SRTP). The keys K₁ to K₄ encrypt the audio streams on each leg of the call and are discarded at the end of each call and are not stored or held anywhere on the phone or secure server.

FIG. 4 labels the audio streams with the keys that encrypt each of the streams. SA uses a different set of keys for each call leg. However during a call, the secure communication servers relay the streams between phones. So for example the stream labeled E which is relayed from the caller to the call recipient is encrypted with K₁ and K₃ while the stream labeled F which is relayed in the reverse direction is encrypted with keys K₂ and K₄. In one embodiment, key material supplied by random number generator (Initialized by an entropy module, to ensure high quality randomness). Additional details relating to the entropy module follow from the data flow in FIG. 3A.

FIG. 3A shows various data flows 100 associated with a call being handled by the SA. In one embodiment, a call is initiated when the end-user interacts with the graphic user interface (GUI). The GUI can include a home interface as shown in FIG. 3B which is discussed in more detail below. In one embodiment, the call request and the target number are passed to the PJSIP module. This module sends a SIP INVITE (defined in RFC 3261) over a previously established TLS connection to the secure servers. When the call is answered, the security servers indicate this by sending a 200 OK message. The INVITE and 200 OK define the media end-points. Outbound media is digitized by VAS (a module included the phone's operating system) and then routed via LIBSRTP where it is encrypted and transmitted as an SRTP stream (defined in RFC 3711) and transmitted to the security servers such as the PBX. Inbound media follows the reverse path.

### Exemplary Secure Real-Time Transport Protocol (SRTP) Encryption Details

Once a secure call has been established, the audio streams are relayed between the call originator and the call destination via the security gateway. Each stream is encrypted using the encryption key generated during call setup and transmitted over the TLS encrypted connections used for the call setup. A user's phone agrees with the counterpart on a session key AES 256. The voice data is captured by the encryption layer, encoded, encrypted and carried on the data channel to the other phone which deciphers the voice using the session key that only it knows.

In one embodiment, there are a total of 4 different encryption keys used when a call is made from one secure phone to another (K1, K2, K3 and K4) as shown in FIG. 2. The 4 audio streams making up a call between two phones are encrypted using the Secure Real-time Transport Protocol (SRTP) and each has a unique key. SRTP is a standard. The mechanism for agreeing SRTP encryption keys is known as for Session Description Protocol (SDP) Security Descriptions for Media Streams) and is a standard. Each call made on a client uses a pair of unique encryption keys. Specifically, there is one key for inbound voice and one key for outbound voice.

K1=Outgoing encrypted audio stream for originator phone (Has own unique encryption key). K2=Incoming encrypted audio stream for originator phone (Has own unique encryption key). K3=Incoming encrypted audio stream for receiving phone (Has own unique encryption key). K4=Outgoing encrypted audio stream for receiving phone (Has own unique encryption key). K1, K2, K3 & K4 are the originator and recipient incoming and outgoing voice audio encryption streams. The encryption keys are generated at the start of every call. What makes the system so secure is that these keys are not stored anywhere in the system and are discarded after each call. The term phone is meant to include mobile device and vice versa. In addition, reference to a first phone, second phone, third phone, etc. can apply to either an originator phone or a receiving phone or both for a given embodiment. In addition, any reference to a first key, a second key, a third key, and a fourth key does not require that these keys correspond to the K1, K2, K3, and K4 keys shown in the figures and described herein although they may in one or more embodiments.

A TLS connection depends on two forms of encryption, asymmetric encryption and symmetric encryption. Asymmetric encryption, also known as public key encryption, uses two keys per phone, per call. One key, which may be published by posting on a web site, is used to encrypt data while another, which must be kept private, is used for decrypting the same data. Asymmetric encryption is computationally expensive and therefore slow and not suitable for bulk data encryption. It is however very effective at providing authentication services and for providing a secure method whereby two devices linked over an insecure network may securely establish a shared secret. This shared secret may be used as an encryption key for a symmetric encryption algorithm.

TLS uses asymmetric encryption to set up a connection and to agree a secret key that is used by a symmetric algorithm for bulk data encryption. When a phone places a call to another phone the call request is transmitted to the configured PBX over the established secure TLS connection. As part of the call request, the originating phone sends a random number which will later be used to encrypt the audio stream sent to the gateway. If the PBX accepts the call request it sends an acknowledgement back to the phone. The gateway adds a random number to the acknowledgement and forwards it to the phone over the TLS connection. The random number added will later be used to encrypt the audio stream sent to the phone.

When the request is received by the PBX, the PBX checks the authorized user database for the target's current location. Assuming the target phone is active, the PBX forwards a call request via the security gateway to the target phone. This request is forwarded via the TLS encrypted connection previously established by the phone. Both the security gateway and the target phone generate random numbers which are transmitted over the TLS encrypted connection and which will be used to encrypt the audio streams between the gateway and the target phone.

It is the replacement of useful, understandable data with a seemingly meaningless arrangement of useless data so that it can only be understood by someone who has the correct decoding ‘key’ or set of ‘keys’. This decoding process allows the conversion of the encrypted data back into its original form, so it can be understood. Encryption is now commonly used in protecting information within many kinds of systems and to protect data in transit, for example data being transferred via networks (e.g. Internet, e-commerce, etc.), wireless systems, money transmission, etc. Encryption, by itself, can protect the confidentiality of data or information, but other techniques are still needed to protect the integrity and authenticity of a message.

When each system authorized phone is powered on or comes within range of a suitable data network, it will establish a secure connection with the configured security gateway and use that connection to register with the configured PBX. This connection will remain established until the phone is powered off or moves out or range of the communications network. This established connection is used for all signaling functions (making calls, accepting calls, terminating calls, etc). This signaling connection is established using the Transport Layer Security (TLS) protocol. TLS is also used to secure connections to web servers where it is more commonly known as SSL.

### Entropy Gathering Module

The Entropy Gathering Module (also known as the random security module or entropy module) seeds the random number generator used within PJSIP to generate encryption keys for RTP and SIP (using SRTP and TLS). Software applications generate encryption keys using a Pseudo Random Number Generator (PRNG). As software is inherently predictable, it is important that PRNGs are seeded with a good source of randomness or “entropy”. The best source of entropy for a software application is external events, many systems monitor network activity for this purpose. In an application that process audio streams, sampling the audio stream provides a good source of entropy. The PJSIP samples the unencrypted outbound audio stream approximately every 30 seconds adding the resulting sample (approx 15 bytes) to the PRNG's entropy pool.

### Clientside Provisioning

The client-side provisioning module is responsible for securely downloading the configuration parameters needed when SA is first installed on a phone. Client side provisioning makes a standard web download request using the phone's number to identify the parameters needed. The configuration download is encrypted using a standard symmetric key cipher, the phone's IMEI and a configuration PIN are used to create the encryption key in one embodiment.

### Voice Quality and Latency

Voice and text encryption is sophisticated technology (digitize, compress, encrypt) and performance can be limited by available software and bandwidth resources leading to latency and jitter. Latency is a measure of the time taken for data packets to be delivered across a network, for example from one phone to another. Jitter is a measure of the variance between the latency of successive packets. To maintain an acceptable level of voice quality, the level of jitter must be kept to a minimum. In one embodiment, an ‘Audio Interface’ (the “AI”) ensures that a high quality secure and encrypted mobile phone service can be provided over all networks including those with limited bandwidth while minimizing latency and jitter. The AI uses a narrow-bandwidth codec to encode analogue signals representing voice into digital data. This data stream is then compressed using the AI compression codec, and encrypted, before it is sent across the data channel.

In one embodiment, the Audio Interface is responsible for reducing secured call bandwidth requirements to below 6 Kbits/second. Most codec's currently require between 20 and 64 Kbits/sec which causes poor call quality. With the necessary overhead of RTP and IP packet headers, the total bandwidth requirement for an audio stream between a phone running the Security Solution and the PBX is approximately 12-14 Kbits/sec. This is within the capability of most GPRS networks which offer a bandwidth range of between 20-56 Kbits/sec. 2G use is a major advantage over potential competitors as 2G capability is vital for effective modern encryption solutions. The GSM association estimates that 80% of the global mobile market uses the 2G standard.

Many phone operators offer a 2G network which has larger coverage than 3G. If a user has a 3G mobile device, in one embodiment, the SA will automatically default to 2G when required. The transition is automatic and transparent. In the absence of 3G or faster networks, existing substandard security applications simply do not work effectively.

### User Interface Embodiments and Features for Mobile Devices

In one embodiment, the invention relates to a software application, such as the SA embodiments described herein designed to provide secure communication for mobile devices or phones (either term is used interchangeably herein). The application is built using a standard Voice over IP (VoIP) protocol. By using this standard, mobile devices may make encrypted calls and also use an encrypted text messaging system. Various exemplary screenshots shown were generated on particular mobile device. Accordingly, various screenshot and user interface details may vary on other mobile devices. The invention is no way limited to one phone type or mobile device.

In the following discussion of illustrative embodiments, a “mobile device” includes, without limitation, mobile phones, remote control devices, personal digital assistants, hand-held computers, ultra-mobile personal computers, Android devices, Apple devices, tablets, and the like. Mobile device preferably includes a processing unit or processor, a system memory, a disk storage, a communication interface, an input device, an output device, and a system bus. System bus couples system components including, but not limited to, system memory to processing unit. The processing unit can be any of various available processors. A secure client application can also be resident in the system memory as shown. The secure application can include various data elements and programs suitable for performing the process steps and calculations. In one embodiment, the secure client application is written in C and C++.

Input device may be a keyboard, thumbboard, or touchscreen that are used to receive data from a user. In addition, input device can also include a plurality of other inputs or controls for adjusting and configuring a mobile device for secure communications. Output device may be a display device, such as an LCD or LED display screen, that can display one or more display objects (not shown) such as configurable icons, buttons, input boxes, menus, tabs, key labels and so forth having multiple configurable dimensions, shapes, colors, text, data and sounds to facilitate operations with mobile device.

The secure client application facilitates data exchange over a variety of wireless networks. In general, the SA selects the highest bandwidth network available to it over the course of call which may change as a user moves.

Storage may include removable or fixed, volatile or non-volatile or permanent or re-writable computer storage media. The computer readable medium can be any available medium that can be accessed by a general purpose or special purpose mobile device. By way of example, and not limitation, such a computer readable medium can comprise flash memory, RAM, ROM, electrically erasable programmable read only memory (EEPROM), optical disk storage, magnetic disk storage or other magnetic storage devices, or any other medium that can be used to store digital information on a mobile device.

It is to be appreciated that the mobile device includes software that acts as an intermediary between users and the basic resources described in mobile device. Such software preferably includes an operating system. The operating system, which can be resident in storage, acts to control and allocate resources of mobile device. System applications, such as SA embodiments, take advantage of the management of resources by the operating system through program modules and program data stored either in system memory or on disk storage. Furthermore, it is to be appreciated that the present invention can be implemented with various operating systems or combinations of operating systems.

The computer readable medium tangibly embodies a program, functions, and/or instructions that cause the computer system to operate in a specific and predefined manner as described herein. Those skilled in the art will appreciate, however, that the process described below relating to media stream encryption, signaling, provisioning and secure communication in general as well as other features recited herein, may be implemented at any level, ranging from hardware to application software. For example, the SA, software, modules, and other front-end and back-end components discussed herein may be implemented as software code to be executed by mobile device using any suitable computer language and may be stored on any of the storage media described above, or can be configured into the logic of mobile device. Such software code may be executed by mobile device using any suitable computer language such as, for example, Java, Javascript, C++, C, C#, Perl, Visual Basic, Transact/Structure Query Language (T/SQL), database languages, APIs, various system-level SDKs, assembly, firmware, microcode, and/or other languages and tools.

These are representative components of a mobile device whose operation is well understood. Furthermore, those of ordinary skill in the art will appreciate that mobile devices shown and described herein are exemplary only and that the present invention can operate within a number of different mobile devices.

### Installing SA

In one embodiment, SA is available as a download on via a server offering applications for mobile devices such as an app store or otherwise pre-installed or acquirable through other channels. While the SA may be downloaded and installed free of change, the handset running the application must be registered with the system in order to use the SA service. The secure communication or data storage service embodiment of the invention itself may have a fee component or subscription. To complete the registration process a user provides their phone's UDID number. This is a unique number that identifies a phone. The UDID number can be displayed by connecting your phone to an app store or other site such as iTunes or an Android or other service and navigating to the device summary page, or by starting the SA and viewing the application startup screen.

### Configuring SA

When the SA is first stared, it is typically configured. The configuration process is automatic. The handset retrieves its configuration parameters from a provisioning server. The configuration parameters are encrypted for transmission over the network and verified by the handset. The provisioning process requires an active Internet connection on the handset. This can be either a Wi-Fi connection or a cellular network data connection. SA will use the handset's default data connection. The amount of data transferred during this process is small (approximately 200 bytes, or 0.2 Kbytes) so the network speed is not important.

To complete the provisioning process and configure a phone for use, a user needs two pieces of information; the handset's standard phone number and a configuration PIN that was supplied when the user subscribed to the Service. The PIN is tied to a specific physical handset. The phone number typically includes the country code and must be entered without spaces. For example if you are in the UK the number will start with 44, if your phone is registered with network provider from the USA the number will start with 1. In one embodiment, the Configuration PIN is a 6 digit number; however, various string lengths can be used.

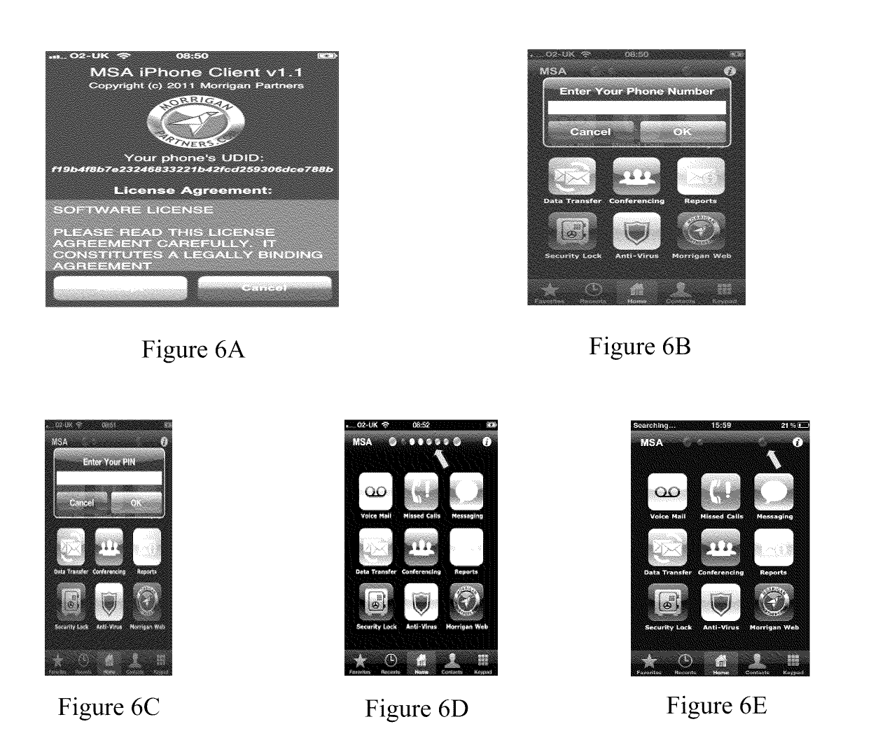

To start the provisioning process, ensure the phone needs an active data connection and then start SA by pressing the application icon. The opening screen of FIG. 6A shows the application version number and the phone's UDID or another unique identifier which is needed to register a given mobile device such as a phone to use the service. Pressing the displayed UDID copies the UDID into the clipboard so that a user may paste it into an email or text message.

To proceed with configuring your handset, a user of the mobile device is asked to accept the terms of the software license which will be displayed on the handset. A user is then prompted for their handset's phone number by a field as shown in the interface screen of FIG. 6B.

In response to the phone number as an input, in one embodiment, the handset will then retrieve its configuration from the provisioning server such as shown in FIG. 5. If this is successful, a user of the mobile device is prompted to enter your configuration PIN in a field as shown in FIG. 6C. If either the phone number or the configuration PIN is incorrect, a user of the mobile device is invited to re-enter them both. In one embodiment, after three failures the application will exit and a user will need to re-start by pressing on the application icon. If both the number and PIN are correct SA running on the mobile device registers with the secure service. When this process is complete the phone is ready to make and receive secure calls.

### Exemplary SA Layout and Operation

The SA uses Voice over IP (VoIP) protocols to relay calls and text messages over and encrypted connection to a PBX. The PBX may be located at a secure hosting center. In one embodiment, all calls and other communications between the phone and the PBX are encrypted. The SA includes a home page. This is the default screen displayed whenever the application is started or brought to the foreground. An exemplary home page is shown in FIG. 3B and in other of the interface screens. The home page also provides icons for each of the main functions. These are Voice Mail, Missed Calls, Text Messaging, Data Transfer, Conferencing, Delivery Reports, Security Lock, Anti-Virus and a link to a system associated Web Site. The navigation bar at the foot of the home screen provides links to other primary screens including Favorites, Recents (call log), Contacts and Keypad (for manually dialing calls).

The home screen also shows the registration status indicator which is pointed to with an arrow in FIG. 6D. When SA is started, the phone will register with the PBX. This registration process establishes a connection between the handset and the PBX which enables the handset to make a receive calls. FIG. 6E shows an interface screen indicating a failed registration. The SA will automatically register when started. If the registration is successful the client will display a successful registration indication as shown in of FIG. 6D. In one embodiment, the SA repeats the registration at regular intervals ensuring that the connection between the handset and the PBX is maintained even if network conditions change. This process is transparent to the user.

If a network connection is lost, for example if the phone moves out of range of a Wi-Fi network and is unable to connect to a 3G network, or moves into an area of low signal strength, SA will automatically attempt to connect via an alternative network. During this process the registration display will change to indicate a failed registration of FIG. 6E. While this screen is displayed a user of the mobile device is unable to make or receive calls. The normal display will be restored as soon as SA is able to reconnect via an available network.

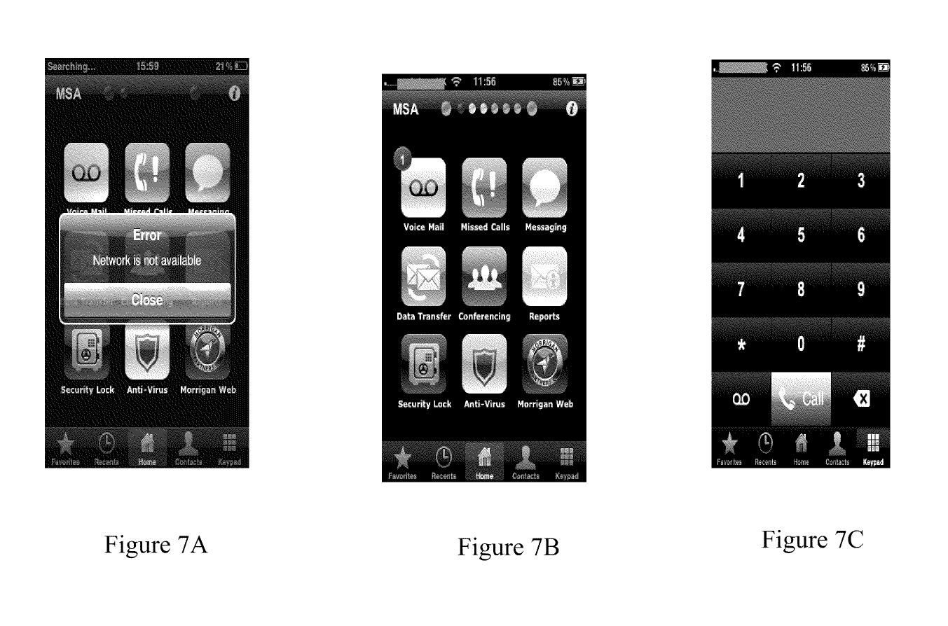

If the SA has been running in background and if a user brings it to the foreground in order to make a call or to send a text then the application will automatically re-register to ensure that it is connected to the optimum network and that the application is ready to make calls or send text messages. During this process it is normal for the registration status display to briefly change state. If the phone is connected to a slow network or is in an area or poor network coverage, then the registration process may take several seconds. If the application is unable to establish a data connection, then an error message will be displayed (see of FIG. 7A). The SA will re-connect as soon as a network becomes available.

### Using Secure Application

The SA is designed to provide a user interface that will be familiar and easy to use for anyone familiar with a mobile device such as an Android phone, an iPhone, a tablet or any other type of communication device. All main functions are available via a series of icons or menus on the SA home screen which is displayed when the application starts. The layout of the home screen is shown in FIGS. 3B and 7B.

### Using Secure Voicemail

The service provides a voicemail box for all registered users. If a called phone is not currently connected to the secure service, if the required user is on a call or if the user does not answer, then the incoming call is directed to voicemail where the caller may leave a message.

The Voice Mail icon on the SA home screen will show the number of new Voice Mail messages, shown as one message in FIG. 7B. To retrieve a message, a user calls the voice mail service by pressing on the Voice Mail icon. Alternatively press the Voice Mail symbol on the Key pad (FIG. 7C). In one embodiment, voice mails are stored on a server which has different levels of security and then are transferred in encrypted format to the mobile device in the same way a voice call would be using one of the systems described herein. The icon referencing Morrigan Web generally refers to any provider or offeror of the SA or the secure services associated therewith. As such, Morrigan Web as an identifier for this icon can be replaced with any suitable provider of the SA or secure services.

The voicemail service provides a multi-level menu which is navigated using the key pad. In all cases the standard voice mail announcement will describe the available options. The top level menu provides the following functions: Listen to messages, Change folders, Advanced options, Repeat, Repeat, Next, Delete, Forward message to another user, Save message, Mail box options, Help, and Exit.

The voicemail system will announce the number of new and old message, pressing 1 will play messages from the new message folder or if there are no new messages, messages from the old folder will be played. Messages are automatically moved from the new message folder to the old message folder when they have been played. Messages may be saved in one of 3 standard folders (work, family or friends) by selecting the save message option. Messages that have been played but not saved will automatically be deleted after 30 days. Pressing zero from the main menu provides access to a second level menu that includes options to set or change a mailbox password and to record personalized greetings. The functions available on this menu are Record Unavailable Message, Record Busy Message, Record Name, Manage temporary greeting, Change/set password, Return to main menu, and Exit.

### Secure Conferencing Embodiment

The secure conferencing system is designed to enable any registered user of the service to schedule conference call or to set up ad-hoc conference calls and to invite any other user of the service to join those calls. This feature uses the same encryption as normal calls. Each participant in a conference call uses an SA on their mobile device. Thus, the software-based system described herein allows multiple participants to the calls in a closed loop system.

Thus, in part, one aspect of the invention relates to methods or systems by which three or more users can participate in a secure conference call over a VoIP channel using the features described herein.

The secure conferencing service is started by selecting the conferencing icon of FIG. 7D, shown as center icon, and pressing the enter key. The secure conferencing service allows a user to select conference participants from their phone book. Each participant will be sent a message inviting them to the conference. The Initiating user may also include a short note describing the purpose of the call. If they accept the invitation they will automatically be connected

In one embodiment, as soon as the invitation list is complete, the SCC will dial a new secure call and connect the initiating user to the conference. The back-end system will send conference call invitations to each user on the invitation list. These invitations will be sent over an encrypted channel. If an invited user's handset is currently registered, a pop-up message will appear on the handset inviting the user to join the call. The pop-up message will include the name of the initiating user. The invited user will have the option to accept or reject the invitation by using the left and right soft-keys. If the invitation is accepted, then the invited user's client will dial a new secure call and connect that user to the conference.

If the invited user rejects the invitation, the initiating user will be notified. The call will continue with each user connected over a secure channel until the last user hangs up from the call. An initiating user is able to set up a call for some future time and date. Invitations will be sent out immediately and delivered as soon as possible. Recipients may accept or reject the invitation on receipt. The back-end system will send reminders to all accepted and all unconfirmed participants 5 minutes before the conference. The reminder will be displayed as a pop-up message; the recipient may defer the reminder or connect to the call by using an input or softkey on the phone.

On joining the conference, each user is prompted to enter a PIN. The PIN will be entered via the key pad. In one embodiment, a different randomized PIN will be used for each conference. The PIN can be notified to users in the invitation/reminder. The benefit is that additional security is provided to prevent other users from accidentally dialing the conference number (conference numbers will be 4 or 5 digit numbers).

The SCC will display a conference summary screen for each user in a conference. This screen will show the names of all attendees and will be displayed while the conference is in progress (in place of the normal SCC call screen). The summary screen will also provide a summary of the conference, including the information needed to enable a user to re-join a conference after leaving. SCC will provide a new conference home screen. This screen will list any scheduled conferences and any active conferences that the user has previously joined and left. This screen will provide a short cut to re-joining an active conference.

### Conference Service Implementation

The conference service will be based on the conference service built-in to the PBX. This offers basic conferencing facilities, users may connect to one of a many pre-defined conference rooms. Each room is optionally protected by a PIN. Without these controls it is possible that an uninvited user could join a conference by dialing the conference room number.

There is no practical limit on the number of rooms that may be created or the number of attendees in each conference. In one embodiment, a conference room is identified by a URI including a number and domain (e.g. 12345 @morriganpartners.com).

Conference invitations and reminders are sent as special format text messages in one embodiment. In one embodiment, these messages are not displayed or stored by the text messaging system but will be directed to a new module within SCC that handles conference invitations. Each message will have two parts, system information that is used internally by SCC (conference room number etc) and user information. User information will be displayed on the handset screen and will include details such as the conference organizer and any optional notes.

### Conferencing Protocol

In one embodiment, messaging associated with the scheduling of conferences will use a simple protocol that will be transmitted using the existing secure text messaging service. These messages will not be directly displayed to end-users and will not appear in the existing message folders or reports. All conferencing messages will be handled by a new conferencing module within SCC. Messages will be exchanged between SCC and the back-end conference scheduling module. Conferencing messages will never be directly exchanged between handsets.

The conferencing protocol is designed so that handset clients are not required to keep state information on any future or active conferences. Clients will be able to retrieve the details needed for the various status screens by sending a message to the back-end. However if clients should cache details of scheduled conferences, this will enable the list of scheduled conferences to be displayed while the handset is offline.

All conferencing protocol messages will be sent over a secure channel. Only handsets registered with the system will be able to send and receive conference protocol messages, additional security will be provided by requiring each message sent by a client to include the handset's IMEI. This implements a simple authentication mechanism. Clients may send conference protocol messages only when there is a valid SIP registration. If this registration expires then the client must re-register before continuing to send messages. The back-end will not attempt to send any protocol messages to a client without a valid registration.

In one embodiment, to differentiate from standard text messages, conferencing protocol messages will be assigned their own message content type. This message content type must be included in all SIP MESSAGE requests that carry a conferencing protocol message. The content type (including SIP header) is:

Content-Type: Text/X-Conference-Protocol

By default, PJSIP accepts text/plain and application/im-is composing+xml content types, some modifications will be needed to enable handsets to accept this format. Alternatively, Content-Type: text/plain could be used, and a new header, for example X-Conference-Protocol: V1, can be used to differentiate these messages from standard text messages. Because conferencing protocol messages use a different content type than standard messages, conferencing protocol messages will not include and X-TextMessage-Id header. In one embodiment, the message body of a conferencing protocol message uses the following structure:

[System]
Directive
Qualifier1
:
QualifierN
[Display]
Free format text message that may be displayed on a user's handset

The fixed string [System] introduces the system section which contains a single directive identifying the message type. The directive is followed by or more qualifiers. The contents of the system section are never displayed on a user's handset. The system section must be present in all messages.

The fixed string [Display] introduced the optional display section. If present the contents of the display section may be displayed on a user's handset. The displayable text will start on the line following the string [Display] and will continue until the end of the message.

Each line of the structured message should be terminated with a Unix new line character (0x0a).

All conferencing protocol messages sent from a handset can be sent to the pre-defined URI, confadmin@local-domain. An example complete conferencing protocol message follows:

MESSAGE sip:confadmin@morriganpartners.com SIP/2.0

| | |
|---|---|
| Via: | SIP/2.0/TLS |

192.168.19.151:35042;rport;branch=z9hG4bKPjTRlTNqqmx
Max-Forwards: 70
From:
<sip:447785333832@morriganpartners.com>;tag=
y4duXqXpIR8fgSAJw3es77zKGGwLnM
To: <sip: confadmin@morriganpartners.com>
Call-ID: zQ5wIUSe6oE5k3spebRgZa.Mgrp7M0yq
CSeq: 2203 MESSAGE
Accept: text/plain, text/X-Conference-Protocol
Contact: <sip:447785333832@192.168.19.151:5061;transport=TLS>
Route: <sip:sip1.morriganpartners.com;transport=tls;lr>
Content-Type: text/X-Conference-Protocol
Content-Length: 280
[System]
Schedule 0
PhoneIdent 355216039977528
Organiser “Peter Cox” <447785333832@morriganpartners.com>
Participant “Robert Bruton” <353872545198@morriganpartners.com>
Participant “Trevor McDermott”
<353871235797@morriganpartners.com>
[Display]
Call to discuss development plans

This secure data transmission service operates within the closed group of users with mobile devices registered with the system. In one embodiment, there will be no external link to Internet email or to other corporate email systems. However, the service is implemented using standard Internet email protocols to facilitate external links should they be required. This feature enable secure transmission of documents between mobile devices and all messages sent between authorized users will be transported over an encrypted network transport service.

### Secure Text Messages

The secure text messaging service allows a user to send a secure text message to any other user of the service. Messages may be sent to users listed in the phone book or to other users if their phone number is known. If the message recipient's handset is active, messages will be delivered immediately, if not, messages will be delivered when the user is next available. In all cases the message sender will be notified when the message is delivered. The text messaging interface is designed to be similar to one or more types of native messaging interfaces available on mobile devices.

### Secure Data Transfer

The Secure Data Transfer service allows users of the secure network to send and receive messages and data files. The service delivers encrypted messages to any other user on the secure network. Messages may be sent to any user in your contacts list. Messages may include attachments; any file available on the handset may be attached to the message, including pictures and videos.

### Missed Calls and Call Logs

The SA Recents screen maintains a record of all calls made or received by the handset and all missed calls as shown in FIG. 7D. In each case the caller or call destination and the time of the call is noted. The call log is reached via the Recents icon on the SA navigation bar. Opening the Recents page displays a list of dialed numbers received calls and missed calls. If SA has received any calls since the Recents screen was last opened and if one or more of those calls was missed, then the Recents icon and he Missed Calls icon will show a missed call as shown in FIG. 7D. Opening the Recents screen displays a combined list of inbound and outbound calls. Outbound calls are indicated by a grey phone symbol (see for example John Smith in FIG. 7D. Inbound calls that were answered are displayed in black while missed calls are displayed in another color or font. Pressing the Missed button at the top of the screen will display only missed calls as shown in FIG. 7E. The missed calls icon on the SA home screen is a short cut to the same page.

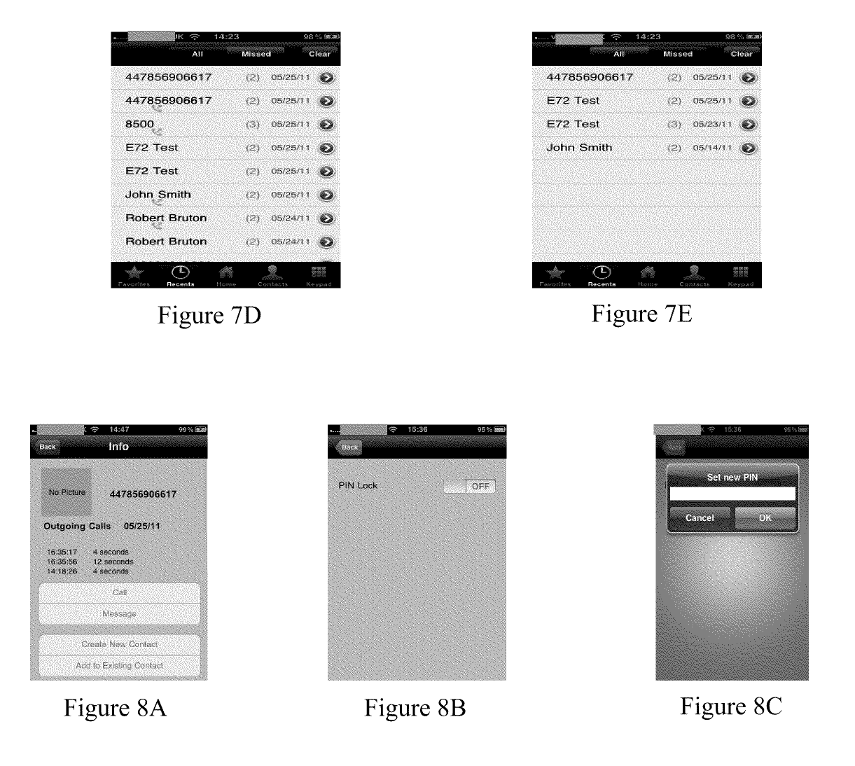

The arrow to the right of each entry displays a summary of the inbound calls from or outbound calls to the selected user as shown in FIG. 8A. A user may also call or send a text message to the selected user by pressing the appropriate button. If the number is not in the contacts list a user may create a new contact or add the number to an existing contact directly from this screen.

### Security Lock

The home screen security lock icon allows you set an SA specific PIN code. This PIN is independent of the any mobile device system PIN. If a PIN is set, a user of the mobile device is prompted to enter it every time that SA is brought to the foreground. To set a PIN, press the Security Lock icon on the SA home screen. This will display the PIN Lock Screen as shown in FIG. 8B. If a user sets PIN Lock to on, the user is prompted to enter and confirm the PIN as shown in FIG. 8C. Any further PIN related operation, including removing or changing the PIN, will require that this PIN is re-entered.

### Additional User Features and Enhancements

### Features for Ensuring VoIP Operation

A number of techniques can be employed by the SA to circumvent potential detection and blocks by network operators in various jurisdictions. The SA can provide a menu of available tools which can be accessed when needed to address many of the situations which might arise. This feature set allows the SA to adjust depending on the jurisdiction and networks available which in turn will facilitate secure calling in different countries and using different network capabilities as needed. Network operators in certain countries have a policy of blocking VoIP traffic and might also have limited 3G availability as they transition to 3G infrastructure.

Thus, various embodiments include features to overcome this technical hurdle. To avoid potential VoIP traffic blocking and/or limited 3G availability, a number of techniques may be employed to circumvent these blocks. These include: (1) relying on home operator or roaming; (2) tunnel media and signalling; (3) obscuring media traffic profile in a tunnel; (4) encrypting media and signalling; and (5) moving media to a non-standard port.

In one embodiment, the SA includes an event manager that monitors changes in network availability and triggers the appropriate actions. In one embodiment, the SA includes a telephony manager to handle multiple simultaneous calls on different networks. In one embodiment, the SA monitors network traffic to detect extended transmission delays. If an extended delay is detected, the client takes the appropriate action, forcing a new registration or a network reconnection as appropriate

### Tunnel Media and Signalling

In areas with 3G availability, this option can be switched on and is a reliable method for defeating network filters by tunnelling both media and signalling in another protocol, for example PPTP or an SSL VPN. Running both signalling and media in the same tunnel will obscure the normal traffic patterns defeating sophisticated filters that look for traffic patterns that are characteristic of VoIP media streams. Tunnelling adds overhead to the data stream which may cause issues on lower bandwidth networks. This option may be turned off using the SA menu. A system embodiment includes features to reduce overhead and create efficiencies in the running of the SA.

### Obscuring Media Traffic Profile in a Tunnel

While tunnelling is likely to defeat most filters, there is still a possibility that a sophisticated filter could deduce the presence of media streams by analysing the packet size and frequency of the tunnelled traffic. While this level of filtering is unlikely, because it would be likely to block other mainstream and high focus legitimate traffic, additional mechanisms could be deployed to defeat even this level of filtering. One technique implemented in the SA is to automatically insert additional traffic into the tunnel to obscure media packet frequency or padding the media frames to ensure that the transmitted packets carrying the tunnelled data are of variable length.

### Encrypt Media and Signalling

The signalling encryption implemented by the SA will circumvent any filters based on content analysis. As SA uses the standard port for TLS encryption of SIP signalling, the signalling could still be blocked by any port based filters. The signalling encryption used will disguise the data preventing its identification as VoIP traffic, but a simple block on the destination port number will still be successful. The media encryption implemented protects media content but sophisticated filters may be able to detect media streams by analysing traffic patterns. Media does not use a fixed port so there is no option to block with a simple destination port filter.

### Move Media to a Non-Standard Port

Moving the TLS encrypted signalling stream from a standard port (5061) to a non-standard port will defeat port based filters. As the data stream is encrypted, other filtering mechanisms will not work. If a commonly used port, for example 443 which is a port currently used for email, is chosen this works on all networks.

### Network Availability Monitoring

As mobile devices move around, the set of networks available to those devices changes. In one area Wi-Fi and 3G may be available, while in another the only option may be GPRS. Mobile device operating systems will automatically connect to an alternative network if a signal is lost; this change is likely to result in a change of IP which will require that the phone re-registers with the PBX. To handle this and to handle the case where a preferred network becomes available, the SA includes an event manager that monitors changes in network availability and triggers the appropriate actions.

### Maintaining Phone Registration

All SIP devices maintain a registration with a PBX. This registration ensures the PBX has details of the device's current IP address so that calls can be routed to the device. The IP address assigned to mobile devices can change as the connected network changes. Some of these changes are handled by the network event manager. The event manager works in conjunction with a registration module which ensures that registrations are maintained at all times.

### Handling Calls on Multiple Networks

Mobile devices running the client will be required to make and accept both secure calls and normal GSM calls. Where the device is connected to a network with sufficient bandwidth, the user should be alerted to calls on one network while there is an active call on another (subject to network operator's requirements for call prioritization). The client includes a telephony manager to handle multiple simultaneous calls on different networks. As an example, if a GSM call is received while a secure call is active, the user will be alerted to the incoming secure call and given the option to accept the GSM call, placing the secure call on hold, or to reject the GSM call.

### Handling Network Transmission Delays

Testing has shown that mobile data networks can sometimes introduce severe delays to data transmission; delays over two minutes have been observed. Delays of this length cause problems for mobile devices because the timeout on operations such as phone registration is typically shorter than this. To handle these problems the client monitors network traffic to detect extended transmission delays. If an extended delay is detected, the client takes the appropriate action, forcing a new registration or a network reconnection as appropriate

### Managing Phone Standby

During an active phone call the phone's standby status must be managed to ensure that essential services are maintained while limiting battery drain. This requires that some services (such as screen lights) are shutdown, but that the phone is not allowed to go into full standby.

### Codec Optimization

As the client is designed to operate on low bandwidth networks, it is important that an efficient codec is used to minimize the bandwidth requirements.

### Additional Features and Embodiments

In one embodiment, the systems and methods described herein allow for various types of secure communication, storage, distribution and retrieval of secure information. In one embodiment, the system allows for secure text message to be broadcast to multiple recipients. These text messages can include time stamps and show a message sent time and/or received time. The settings in the SA provide for selection of back-end system with a local default set by provisioning. In addition, the provisioning system can include various processes or steps relating to transmitting data to a mobile device such that it can use the secure services described herein. These processes or steps can include Registering of mobile devices and selection of preferred hosting center; automatic expiry of registration at end of contract period; manual early termination of contract; supporting multiple domains; and providing for links to external systems (e.g. SA users with their own PBX). In addition, with respect to the back-end systems, embodiment of the invention include multiple domain support and call routing and geographic failover (mobile devices register via a secondary center if primary fails).

### Alternate Transport Port

While the majority of network operators allow any application to operate over their data services, some operators may place restrictions on applications such as VoIP. One method for restricting the use of an application is for the operator to block the well-known port reserved for that application. For example, the well-known port reserved or preset port for SIP running over an encrypted connection is 5061. In one embodiment, the SA uses this port by default. However, the port managing embodiments described herein can be extended to any pre-selected, preset or otherwise typically reserved port.

In the event that the SA is unable to connect over that port, the SA will try a secondary port. The secure communication servers are configured to accept connections on both the primary and secondary port. The secondary port used is determined by provisioning, but is normally a port used for email services which operators are unlikely to block.

If the client is unable to connect to the secure communication servers, but is able to connect on the secondary port, the client application will continue to use the secondary port until the application is restarted or until network conditions change.

### Message Delivery Reports

One embodiment of the invention also includes a text messaging option that provides time-stamped delivery reports. These reports are generated by the secure communication servers such as the PBX described above when a message is successfully delivered to the intended recipient's handset. The reports are sent back to the originating phone which uses the information contained in the delivery report to record the delivery time of that message. This information is displayed in the text messaging reports folder.

The use of headings and sections in the application is not meant to limit the invention; each section can apply to any aspect, embodiment, or feature of the invention.

Throughout the application, where compositions are described as having, including, or comprising specific components, or where processes are described as having, including or comprising specific process steps, it is contemplated that compositions of the present teachings also consist essentially of, or consist of, the recited components, and that the processes of the present teachings also consist essentially of, or consist of, the recited process steps.

In the application, where an element or component is said to be included in and/or selected from a list of recited elements or components, it should be understood that the element or component can be any one of the recited elements or components and can be selected from a group consisting of two or more of the recited elements or components. Further, it should be understood that elements and/or features of a composition, an apparatus, or a method described herein can be combined in a variety of ways without departing from the spirit and scope of the present teachings, whether explicit or implicit herein.

The use of the terms “include,” “includes,” “including,” “have,” “has,” or “having” should be generally understood as open-ended and non-limiting unless specifically stated otherwise.

The use of the singular herein includes the plural (and vice versa) unless specifically stated otherwise. Moreover, the singular forms “a,” “an,” and “the” include plural forms unless the context clearly dictates otherwise. In addition, where the use of the term “about” is before a quantitative value, the present teachings also include the specific quantitative value itself, unless specifically stated otherwise.

It should be understood that the order of steps or order for performing certain actions is immaterial so long as the present teachings remain operable. Moreover, two or more steps or actions may be conducted simultaneously.

Where a range or list of values is provided, each intervening value between the upper and lower limits of that range or list of values is individually contemplated and is encompassed within the invention as if each value were specifically enumerated herein. In addition, smaller ranges between and including the upper and lower limits of a given range are contemplated and encompassed within the invention. The listing of exemplary values or ranges is not a disclaimer of other values or ranges between and including the upper and lower limits of a given range. Computer Based Embodiments of the Secure Communication Systems, Methods, and Apparatus

The present invention may be embodied in many different forms, including, but in no way limited to, computer program logic for use with a processor (e.g., a microprocessor, microcontroller, digital signal processor, or general purpose computer), programmable logic for use with a programmable logic device, (e.g., a Field Programmable Gate Array (FPGA) or other PLD), discrete components, integrated circuitry (e.g., an Application Specific Integrated Circuit (ASIC)), or any other means including any combination thereof.

In one embodiment of the present invention, some or all of the encrypted signals and keys and mobile device interfaces for controlling the SA are processed and transformed using a set of computer program instructions or software instructions that is converted into a computer executable form, stored as such in a computer readable medium, and executed by a microprocessor under the control of an operating system. In one embodiment, data received from a PBX indicating that a mobile device has been registered for one of the secure data transmission or storage services is transformed into processor-understandable instructions suitable for generating a secure communication session between two or more mobile devices, secure text messages, secure voicemail, and other secure features and other processes, transformations, features and embodiments as described above.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, C#, JAVA, or HTML) for use with various operating systems or operating environments.

The source code may define and use various data structures, methods, and instructions relating to or suitable for implementing the embodiments described herein including SIP, event management, entropy collection, PBX registration, and various other features described herein. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device.

The computer program may be fixed in any form in a signal that is transmittable to a computer using any of various communication technologies, including, but in no way limited to, analog technologies, digital technologies, optical technologies, wireless technologies networking technologies, and internetworking technologies. The computer program may be distributed in any form as a removable storage medium with accompanying printed or electronic documentation (e.g., shrink-wrapped software), preloaded with a computer system (e.g., on system ROM or fixed disk), or distributed over a network.

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink-wrapped software), preloaded with a computer system (e.g., on system ROM or fixed disk), or distributed from a server or electronic bulletin board over the communication system (e.g., the Internet or World Wide Web).

Various examples of suitable processing modules are discussed below in more detail. As used herein a module or software module refers to software, hardware, or firmware suitable for performing a specific data processing, data transmission task or other automated function or process using a processor or computer. Typically, in one embodiment a module refers to a software routine, program, or other memory resident application suitable for transforming, receiving, encrypting, entropy collecting, event managing, network sampling, pseudo number generating, mobile device registering, codec processing, PBX communicating, and processing instructions, or various types of signals, protocols, user data, digitized voice signals, codecs, events, signals, vectors, code segments, keys, information or data of interest described herein or otherwise relating to the embodiments of the invention.

Computers and computer systems described herein may include operatively associated computer-readable media such as memory for storing software applications used in obtaining, processing, storing and/or communicating data. It can be appreciated that such memory can be internal, external, remote or local with respect to its operatively associated computer or computer system.

Memory may also include any means for storing software or other instructions including, for example and without limitation, a hard disk, an optical disk, floppy disk, DVD (digital versatile disc), CD (compact disc), memory stick, flash memory, ROM (read only memory), RAM (random access memory), DRAM (dynamic random access memory), PROM (programmable ROM), EEPROM (extended erasable PROM), and/or other like computer-readable media.

In general, computer-readable memory media applied in association with embodiments of the invention described herein may include any memory medium capable of storing instructions executed by a programmable apparatus. Where applicable, method steps described herein may be embodied or executed as instructions stored on a computer-readable memory medium or memory media.

It is to be understood that the figures and descriptions of the invention have been simplified to illustrate elements that are relevant for a clear understanding of the invention, while eliminating, for purposes of clarity, other elements. Those of ordinary skill in the art will recognize, however, that these and other elements may be desirable. However, because such elements are well known in the art, and because they do not facilitate a better understanding of the invention, a discussion of such elements is not provided herein. It should be appreciated that the figures are presented for illustrative purposes and not as construction drawings. Omitted details and modifications or alternative embodiments are within the purview of persons of ordinary skill in the art.

It can be appreciated that, in certain embodiments of the invention, a single component may be replaced by multiple components, and multiple components may be replaced by a single component, to provide an element or structure or to perform a given function or functions. Except where such substitution would not be operative to practice certain embodiments of the invention, such substitution is considered within the scope of the invention.

The examples presented herein are intended to illustrate potential and specific implementations of the invention. It can be appreciated that the examples are intended primarily for purposes of illustration of the invention for those skilled in the art. There may be variations to these diagrams or the operations described herein without departing from the spirit of the invention. For instance, in certain cases, method steps or operations may be performed or executed in differing order, or operations may be added, deleted or modified.

Furthermore, whereas particular embodiments of the invention have been described herein for the purpose of illustrating the invention and not for the purpose of limiting the same, it will be appreciated by those of ordinary skill in the art that numerous variations of the details, materials and arrangement of elements, steps, structures, and/or parts may be made within the principle and scope of the invention without departing from the invention as described in the claims.

What is claimed is:

1. A secure communication system, the system comprising:
a memory device; and
a processor in communication with the memory device, wherein the memory device comprises instructions that when executed by the processor cause the processor to:
validate a first mobile device;
transmit a second key to the first mobile device; and
initiate a secure internet-based voice call between the first mobile device and a second previously validated mobile device.

2. The system of claim 1 further comprising a conferencing module configured to cause the processor to execute instructions that cause the processor to initiate a secure connection between the first mobile device and two or more mobile devices for a secure conference call in response to selection of an icon on a user interface of the first mobile device.

3. The system of claim 1 wherein the instructions that when executed by the processor further cause the processor to transmit a fourth key to the second mobile device in response to a third key sent from the mobile device.

4. The system of claim 3 wherein the instructions that when executed by the processor further cause the processor to delete or cause the deletion of the second key and the fourth key after the secure internet-based voice call terminates.

5. The system of claim 3 further comprising a private branch exchange server, wherein the processor and memory device is disposed therein.

6. The system of claim 3 further comprising a database executing in the memory device and in communication with the processor, the database comprising registered user information for a secure service and information relating to mobile devices of such users.

7. The system of claim 6 further comprising a secure VoIP gateway comprising an entropy module, a random number generator, and a network sampling module, wherein the entropy module receives signals obtained by the network sampling module and generates an entropy amount, the random number generator receiving and seeded by the entropy amount, wherein the random number generator generates at least one of a first key, the second key, a third key, or a fourth key.

8. The system of claim 1 wherein the first mobile device comprises a memory, a mobile processor, an audio input, and an a secure application stored in memory, the secure application comprising a low bandwidth codec stored in memory that operates with the processor to encode voice signals received from the audio input and to encrypt such encoded voice signals using the second key.

9. The system of claim 1 wherein the instructions that cause the processor to validate a first mobile device perform such validation in response to a first key sent from the first mobile device or a unique mobile device identifier such as the first mobile device's standard number, the first mobile device's International Mobile Equipment Identity (IMEI), or the first mobile device's Unique Device Identifier (UDID) and a configuration PIN registered to the user of the first mobile device.

10. The system of claim 1 further comprising a security module selected from the group consisting of a secure voicemail module configured to received encrypted voicemail messages on a mobile device; a secure text messages module configured to send and receive encrypted text messages on a mobile device; and a secure storage module configured to store secure text, voice, and other data on a mobile device.

11. A secure communication system, the system comprising:
a voice call processing server;
a user database in communication with the server; and
a security gateway in communication with the server and the database, wherein the gateway transmits an encrypted signaling key and at least one encrypted media key in response to validating a mobile device using configuration data stored in the database, wherein the server tracks call traffic encrypted using the at least one media key, the call traffic routed using the Internet.

12. The system of claim 11 wherein the call traffic is encoded using a low bandwidth codec such that the encrypted call traffic can be transmitted over a 2G network.

13. The system of claim 11 wherein the encrypted signally key is generated by a random number generator seeded with noise collected with respect to a communication channel of the Internet.

14. A method of conducting a secure communication between a first mobile device and a second mobile device, the method comprising the steps of:
transmitting a first request for a first secure communication from a first mobile device to a secure VoIP gateway;
transmitting a first key from the first mobile device to the secure VoIP gateway;
receiving, by the first mobile device, a second key from the secure VoIP gateway; and
encrypting a first communication using the second key to obtain a first encrypted communication.

15. The method of claim 14 further comprising the step of transmitting the first encrypted communication to a second mobile device.

16. The method of claim 14 wherein the first communication is selected from the group consisting of a text message, an email message, a voice signal, and a voicemail message.

17. The method of claim 15 wherein the first communication is an encoded voice signal.

18. The method of claim 17 wherein the encoded voice signal was encoded using a low bandwidth codec.

19. The method of claim 15 further comprising the step of deleting the first key and the second key after the first secure communication terminates between the first and the second mobile devices.

20. The method of claim 15 further comprising the steps of using a media stream to transmit one of the first or second keys and using a SIP signaling stream to transmit the other of the first or second keys.
